(19) United States
(12) Patent Application Publication
(10) Pub. No.: US 2026/0276962 A1
(43) Pub. Date: Sep. 17, 2026

(54) DISK UNIT, CONFOCAL SCANNER, AND CONFOCAL MICROSCOPE

(71) Applicant: YOKOGAWA ELECTRIC CORPORATION, Tokyo (JP)

(72) Inventors: Takayuki KEI, Musashino-shi (JP); Nao KOISHIHARA, Musashino-Shi (JP); Naoki ANDOH, Musashino-Shi (JP); Takuya AZUMA, Musashino-Shi (JP)

(73) Assignee: YOKOGAWA ELECTRIC CORPORATION, Musashino-shi, Tokyo (JP)

(21) Appl. No.: 19/167,933

(22) PCT Filed: Jan. 30, 2024
(86) PCT No.: PCT/JP2024/002753

§ 371 Date: Sep. 23, 2025

(30) Foreign Application Priority Data
Mar. 30, 2023 (JP) 2023-054666

(51) Int. Cl. G02B 21/00; G02B 21/04

(52) U.S. Cl. CPC G02B 21/0032; G02B 21/006; G02B 21/0068; G02B 21/04

(57) ABSTRACT

A disk unit includes a first disk that has first and second regions divided in a radial direction, and a second disk that has first and second regions divided in the radial direction correspondingly to the first disk and rotating together with the first disk. Microlenses are provided in the first region and the second region of the first disk. A reflection mirror reflecting light which has been transmitted through the microlenses provided in either one of the first region or the second region of the first disk toward the microlenses is provided in either one of the first region or the second region of the second disk. Pinholes corresponding to the microlenses provided in the other of the first region and the second region of the first disk are provided in the other of the first region and the second region of the second disk.

### TECHNICAL FIELD

The present invention relates to a disk unit, a confocal scanner, and a confocal microscope.

### BACKGROUND ART

In recent years, a technology of imaging samples such as tissues, organs, and cells of a living body into two-dimensional images or three-dimensional images using a disk scanning-type confocal microscope has been attracting attention. With this technology, confocal images of samples are obtained by rotating a disk unit and changing an irradiation position of illumination light (excitation light) with respect to a sample (scanning a sample with illumination light). Since only information on a focal plane is obtained, this technology has an advantage in obtaining images having excellent resolution and contrast.

The following Patent Literature 1 (PTL 1) discloses a confocal microscope provided with a reflection mirror between a microlens array disk and a pinhole array disk constituting a disk unit (refer to FIG. 6). In this confocal microscope, illumination light which has passed through the microlens array disk is reflected by the reflection mirror and is caused to pass through the microlens array disk again, and a confocal image is obtained by irradiating an irradiation surface provided in the microlens array disk with illumination light having a uniform intensity. In this manner, the confocal microscope of the following Patent Literature 1 obtains a high-definition confocal image having a uniform brightness using the microlens array disk constituting a part of a confocal optical system as a microlens array disk constituting a part of a homogenizer.

### CITATION LIST

### Patent Literature

### PTL 1

Japanese Patent No. 7180707

### SUMMARY OF INVENTION

### Technical Problem

Incidentally, in the confocal microscope disclosed in Patent Literature 1 described above, as described above, the microlens array disk of the disk unit is used as a microlens array disk constituting a part of a confocal optical system and a microlens array disk constituting a part of a homogenizer. For this reason, the microlens array disk constituting a part of the confocal optical system and the microlens array disk constituting a part of the homogenizer cannot be individually designed. For instance, if an optimal microlens array disk constituting a part of the confocal optical system and an optimal microlens array disk constituting a part of the homogenizer could be individually designed, it is thought that a high-definition confocal image having a further improved uniform brightness could be obtained.

In addition, in the confocal microscope disclosed in Patent Literature 1 described above, there is a need to provide a reflection mirror at a position between the microlens array disk and the pinhole array disk constituting the disk unit. For this reason, a mechanism for adjusting the position and the reflection angle of the reflection mirror is required, and this will cause increase in the number of components and rise in costs.

The present invention has been made in consideration of the foregoing circumstances, and an object thereof is to provide a disk unit, a confocal scanner, and a confocal microscope capable of obtaining a high-definition confocal image having a further improved uniform brightness using fewer components than those in the related art.

### Solution to Problem

In order to resolve the foregoing problems, a disk unit (24) according to a first aspect of the present invention includes a first disk (24a) that has a first region (Z11) and a second region (Z12) divided in a radial direction, and a second disk (24b) that has a first region (Z21) and a second region (Z22) divided in the radial direction correspondingly to the first disk and rotates together with the first disk while having the other surface disposed in a manner of facing one surface of the first disk. A plurality of microlenses (ML1 and ML2) are provided in the first region and the second region of the first disk, and a reflection mirror (RM) reflecting light which has been transmitted through the microlenses provided in either one of the first region or the second region of the first disk toward the microlenses is provided in either one of the first region or the second region of the second disk. A plurality of pinholes (PH) corresponding to the microlenses provided in the other of the first region and the second region of the first disk are provided in the other of the first region and the second region of the second disk.

In addition, according to the disk unit of a second aspect of the present invention, in the disk unit according to the first aspect of the present invention, the microlenses (ML1) provided in the first region of the first disk and the microlenses (ML2) provided in the second region of the first disk differ from each other in kind.

In addition, according to the disk unit of a third aspect of the present invention, in the disk unit according to the first or second aspect of the present invention, the microlenses (ML2) provided in the second region of the first disk are disposed in a spiral shape.

In addition, according to the disk unit of a fourth aspect of the present invention, in the disk unit according to any one of the first to third aspects of the present invention, focal distances of the microlenses provided in either one of the first region or the second region of the first disk are twice focal distances of the microlenses provided in the other of the first region and the second region of the first disk.

In addition, according to the disk unit of a fifth aspect of the present invention, in the disk unit according to any one of the first to fourth aspects of the present invention, planar shapes of the microlenses provided in at least one of the first region and the second region of the first disk are circular shapes or rectangular shapes.

In addition, according to the disk unit of a sixth aspect of the present invention, the disk unit according to any one of the first to fifth aspects of the present invention further includes a coupling shaft (24c) that connects the first disk and the second disk, and a drive unit (24d) that rotatively drives the coupling shaft.

In addition, a confocal scanner according to a first aspect of the present invention includes the disk unit (24) according to any one of the first to sixth aspects of the present invention, light induction units (22, 23, 25, and 26) that form a Koehler illumination system together with the microlenses within a first illumination region (R11) set in either one of the first region or the second region of the first disk and induce a plurality of rays of split light (L3) split by the microlenses within the first illumination region into a second illumination region (R12) set in the other of the first region and the second region of the first disk, and a beam splitter (27) that is disposed between one surface of the first disk and the other surface of the second disk, allows light through the microlenses within the second illumination region to be transmitted therethrough, and reflects light incident from the second disk side toward an outward side of the first disk and the second disk in the radial direction.

In addition, according to the confocal scanner of a second aspect of the present invention, in the confocal scanner according to the first aspect of the present invention, the light induction units include a polarization beam splitter (22) which allows light in a first polarization state to be transmitted therethrough and reflects light in a second polarization state; a ¼ wavelength plate (23) which is disposed between the polarization beam splitter and the first disk, converts light in the first polarization state which has been transmitted through the beam splitter into light in a third polarization state, and converts the split light in the third polarization state into light in the second polarization state; a split light guide unit (26) which guides the split light reflected by the polarization beam splitter to the second illumination region; and a Fourier lens (25) which is disposed in an optical path of the split light and forms a part of the Koehler illumination system.

A confocal microscope (1) according to an aspect of the present invention includes the confocal scanner according to the first or second aspect of the present invention emitting illumination light (LA) for scanning a sample (SP), a light source unit (10) that outputs light (L1) for generating the illumination light, and an image capturing device (40) that captures an image of a confocal image of the sample.

### Advantageous Effects of Invention

According to the present invention, there is an effect that a high-definition confocal image having a further improved uniform brightness can be obtained using fewer components than those in the related art.

### BRIEF DESCRIPTION OF DRAWINGS

FIG. 1 is a view illustrating a constitution of a main part of a confocal microscope according to an embodiment of the present invention.

FIG. 2A is a plan view illustrating a constitution of a microlens array disk of a disk unit according to the embodiment of the present invention.

FIG. 2B is a plan view illustrating a constitution of a pinhole array disk of a disk unit according to the embodiment of the present invention.

FIG. 3 is a development view linearly illustrating an optical path from a light source to a second irradiation surface in the embodiment of the present invention.

FIG. 4A is a plan view illustrating a first modification example of the microlens array disk provided in the disk unit.

FIG. 4B is a plan view illustrating a first modification example of the pinhole array disk provided in the disk unit.

FIG. 5 is a plan view illustrating a second modification example of the microlens array disk provided in the disk unit.

FIG. 6 is a plan view illustrating a third modification example of the microlens array disk provided in the disk unit.

FIG. 7 is a plan view illustrating a fourth modification example of the microlens array disk provided in the disk unit.

FIG. 8 is a plan view illustrating a fifth modification example of the microlens array disk provided in the disk unit.

### DESCRIPTION OF EMBODIMENTS

Hereinafter, a disk unit, a confocal scanner, and a confocal microscope according to an embodiment of the present invention will be described in detail with reference to the drawings. Hereinafter, first, an overview of the embodiment of the present invention will be described, and details of each of the embodiments of the present invention will subsequently be described.

### Overview

The embodiment of the present invention provides a disk unit, a confocal scanner, and a confocal microscope capable of obtaining a high-definition confocal image having a further improved uniform brightness using fewer components than those in the related art. The embodiment of the present invention can be applied to not only confocal laser microscope systems but also products such as drug discovery support devices utilizing a confocal laser microscope method.

In the foregoing products, for example, a laser light source which can be regarded as a point light source is expanded using a collimating lens or the like such that it serves as a two-dimensional surface light source. Thereafter, light thereof is applied to a sample such as a cell through an optical system (an objective lens or the like) of a confocal laser microscope and excites the sample. A fluorescent material has been fused with the cell in advance, and fluorescence is emitted from the cell when excitation light is received. An image of the fluorescence is captured using a microscopic optical system, and observation of the cell or analysis of behavior of the cell is performed. Such confocal microscopes are utilized throughout the fields from basic research of organisms to application and development of drug discovery.

When a cell image is captured, in order to obtain a high definition without blur, a confocal method using a pinhole array disk is utilized for an optical system. In addition, in order to enhance the utilization efficiency of illumination light, a microlens array disk provided with microlenses in one-to-one correspondence with pinholes on a pinhole array is provided. A confocal scanner using such a microlens array disk and a pinhole array disk is a basic tool used when images of living cells are captured. Moreover, it is preferable to use a homogenizer which makes the intensity of illumination light (excitation light) uniform over the entire surface such that an image has a uniform brightness over the entire surface.

Both the confocal microscope in the related art disclosed in the foregoing Patent Literature 1 and the confocal microscope according to the embodiment of the present invention involves two technologies, such as a confocal scanner technology which realizes a confocal microscopy method and a homogenizer technology which makes illumination light uniform. The confocal scanner technology is the same for both the confocal microscopes: the confocal microscope in the related art and the confocal microscope according to the embodiment of the present invention. For this reason, hereinafter, the homogenizer technology which differs between both the confocal microscopes will be described.

The foregoing Patent Literature 1 discloses a confocal microscope which obtains a high-definition confocal image having a uniform brightness using a microlens array disk constituting a part of a confocal optical system as a microlens array disk constituting a part of a homogenizer. This confocal microscope includes a reflection mirror between the microlens array disk and a pinhole array disk constituting a disk unit. Further, illumination light which has passed through the microlens array disk is reflected by the reflection mirror and is caused to pass through the microlens array disk again, and a confocal image is obtained by irradiating an irradiation surface provided in the microlens array disk with illumination light having a uniform intensity.

Here, in the confocal microscope disclosed in the foregoing Patent Literature 1, as described above, a microlens array disk constituting a part of a disk unit is used as a microlens array disk constituting a part of a confocal optical system and a microlens array disk constituting a part of a homogenizer. For this reason, the microlens array disk constituting a part of the confocal optical system and the microlens array disk constituting a part of the homogenizer cannot be individually designed.

For this reason, if the microlens array disk is designed such that the confocal optical system has the best optical characteristics, the homogenizer may not have the best optical characteristics. On the contrary, if the microlens array disk is designed such that the homogenizer has the best optical characteristics, the confocal optical system may not have the best optical characteristics. In such a case, for instance, if an optimal microlens array disk constituting a part of the confocal optical system and an optimal microlens array disk constituting a part of the homogenizer can be individually designed, it is thought that a high-definition confocal image having a further improved uniform brightness can be obtained.

In addition, in the confocal microscope disclosed in the foregoing Patent Literature 1, there is a need to provide a reflection mirror at a position between the microlens array disk and the pinhole array disk constituting the disk unit. For this reason, a mechanism for adjusting the position and the reflection angle of the reflection mirror is required, and this will cause increase in the number of components and rise in costs.

The disk unit according to the embodiment of the present invention includes a first disk that has a first region and a second region divided in a radial direction. In addition, the disk unit includes a second disk that has a first region and a second region divided in the radial direction correspondingly to the first disk and rotates together with the first disk while having the other surface disposed in a manner of facing one surface of the first disk.

A plurality of microlenses are provided in the first region and the second region of the first disk. In addition, a reflection mirror reflecting light which has been transmitted through the microlenses provided in either one of the first region or the second region of the first disk toward the microlenses is provided in either one of the first region or the second region of the second disk. Further, a plurality of pinholes corresponding to the microlenses provided in the other of the first region and the second region of the first disk are provided in the other of the first region and the second region of the second disk.

According to such a disk unit of the embodiment of the present invention, light which has been transmitted through the microlenses provided in either one (for example, the first region) of the first region or the second region of the first disk is reflected by the reflection mirror provided in either one (for example, the first region) of the first region or the second region of the second disk. Light reflected by the reflection mirror is transmitted through the microlenses provided in either one (for example, the first region) of the first region or the second region of the first disk again. Accordingly, a part of the homogenizer is constituted. In this manner, in the present embodiment, since a reflection mirror is provided in either one of the first region or the second region of the second disk and the reflection mirror which has been required in the related art is no longer required, a constitution having fewer components than in the related art can be realized.

In addition, according to the disk unit of the embodiment of the present invention, the microlenses are provided in the other (for example, the second region) of the first region and the second region of the first disk. In addition, a plurality of pinholes corresponding to the microlenses provided in the other (for example, the second region) of the first region and the second region of the first disk are provided in the other (for example, the second region) of the first region and the second region of the second disk. Accordingly, a part of the confocal optical system is constituted.

Here, the microlenses provided in either one (for example, the first region) of the first region or the second region of the first disk and the microlenses provided in the other (for example, the second region) of the first region and the second region of the first disk can be individually designed. For this reason, a microlens array disk optimal for a homogenizer and a microlens array disk optimal for a confocal optical system can be individually designed. Accordingly, a high-definition confocal image having a further improved uniform brightness can be obtained.

### Embodiment

### Constitution of Confocal Microscope

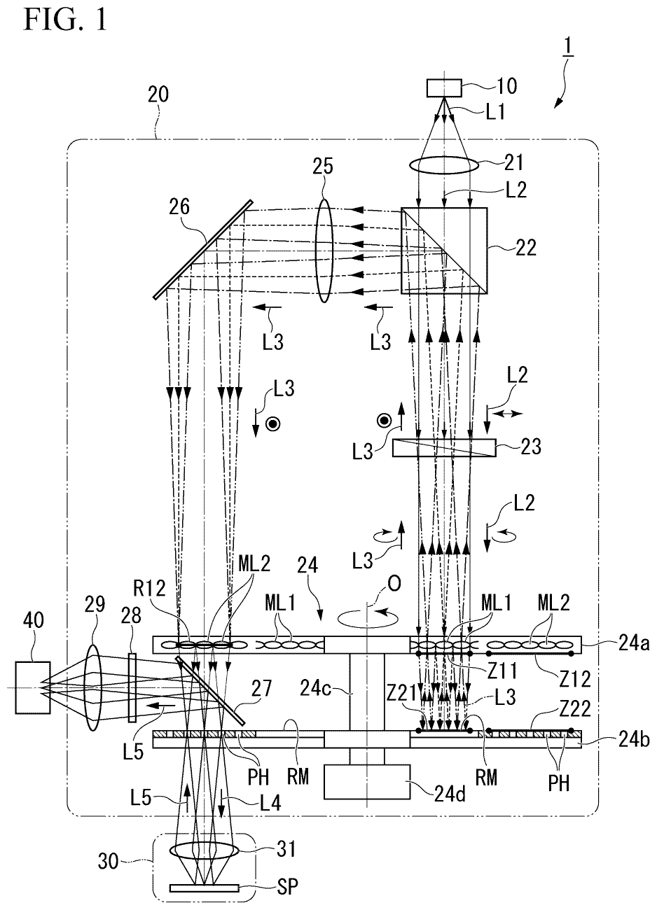

FIG. 1 is a view illustrating a constitution of a main part of a confocal microscope according to an embodiment of the present invention. As illustrated in FIG. 1, a confocal microscope 1 of the present embodiment includes a light source unit 10, a confocal scanner 20, a microscope 30, and a camera 40 (image capturing device). In such a confocal microscope 1, the confocal scanner 20 generates illumination light (excitation light) LA for scanning a sample SP from light L1 output from the light source unit 10, and the camera 40 obtains a confocal image of the sample SP irradiated with the illumination light LA.

The light source unit 10 outputs the light L1 required to illuminate the sample SP toward the confocal scanner 20. In the present embodiment, it is assumed that the light L1 output from the light source unit 10 is P-polarized light. The light L1 output from the light source unit 10 may be coherent light (laser light) or may be incoherent light. In the present embodiment, in order to facilitate understanding, it is assumed that light output from the light source unit 10 is laser light. The light source unit 10 outputs the light L1 having a wavelength range of 400 to 800 [nm], for example. The wavelength range of the light L1 output from the light source unit 10 is not limited to the foregoing wavelength range (400 to 800 [nm]) and may be an arbitrary wavelength range which suits the optical characteristics of the sample SP.

The confocal scanner 20 generates the illumination light LA for scanning the sample SP from the light L1 output from the light source unit 10 and induces reflected light, fluorescence, and the like (when these are generically referred to hereinafter, they will be simply referred to as “return light L5”) obtained by irradiating the sample SP with the illumination light LA to the camera 40. The confocal scanner 20 includes a collimating lens 21, a polarization beam splitter 22 (light induction unit), a ¼ wavelength plate 23 (light induction unit), a disk unit 24, a Fourier lens 25 (light induction unit), a reflection mirror 26 (light induction unit, split light guide unit), a dichroic mirror 27 (beam splitter), an optical filter 28, and a relay lens 29.

The collimating lens 21 converts the light L1 output from the light source unit 10 into parallel light L2. Since the light L1 output from the light source unit 10 is P-polarized light, the parallel light L2 is also P-polarized light. In the present embodiment, the light L1 output from the light source unit 10 has a certain spread angle. The collimating lens 21 converts the light L1 having such a certain spread angle into the parallel light L2. When the light L1 output from the light source unit 10 is parallel light, the collimating lens 21 can be omitted.

The polarization beam splitter 22 is disposed on an optical path of the parallel light L2, allows P-polarized light (light in a first polarization state) to be transmitted therethrough, and reflects S-polarized light (light in a second polarization state) toward the Fourier lens 25. In the present embodiment, since the light L1 output from the light source unit 10 is P-polarized light and the parallel light L2 is also P-polarized light, the polarization beam splitter 22 allows the parallel light L2 to be transmitted therethrough. Meanwhile, as will be described below, split light L3 input to the polarization beam splitter 22 is S-polarized light. For this reason, the polarization beam splitter 22 reflects the input split light L3.

The ¼ wavelength plate 23 is disposed between the polarization beam splitter 22 and the disk unit 24. The ¼ wavelength plate 23 is an optical element which changes the phase of input light by ¼ wavelength and outputs the phase-changed light. The ¼ wavelength plate 23 converts the parallel light L2 (P-polarized light) output from the polarization beam splitter 22 into circularly polarized light (light in a third polarization state) and outputs the converted light. In addition, the ¼ wavelength plate 23 converts the split light L3 (circularly polarized light) output from the disk unit 24 into S-polarized light and outputs the converted light.

The disk unit 24 generates the illumination light LA for scanning the sample SP from the parallel light L2 (circularly polarized light) output from the ¼ wavelength plate 23. The disk unit 24 includes a microlens array disk 24a (first disk), a pinhole array disk 24b (second disk), a rotation shaft 24c (coupling shaft), a motor 24d (drive unit), and the like.

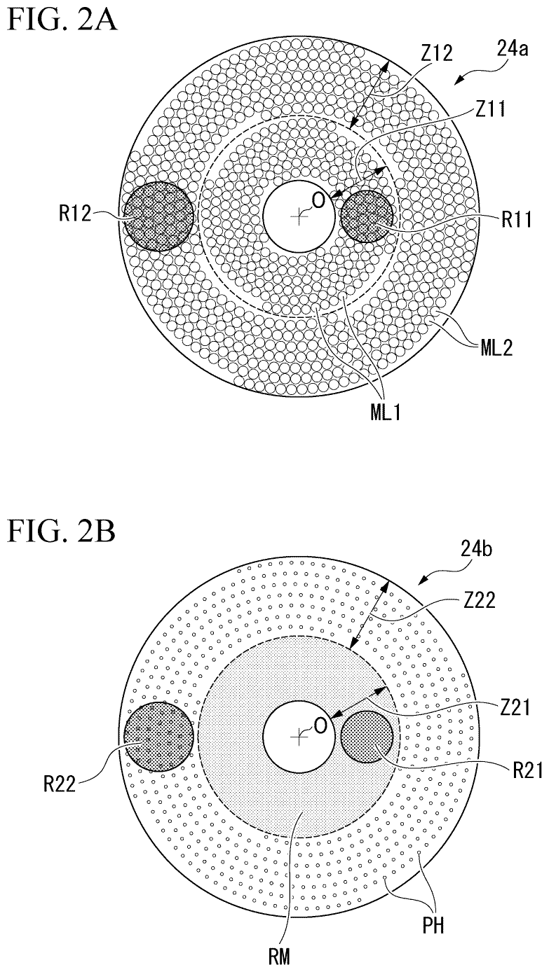

FIG. 2 is a plan view illustrating a constitution of the microlens array disk and the pinhole array disk of the disk unit according to the embodiment of the present invention. FIG. 2A is a plan view of the microlens array disk 24a provided in the disk unit 24, and FIG. 2B is a plan view of the pinhole array disk 24b provided in the disk unit 24.

As illustrated in FIG. 2A, the microlens array disk 24a is a disk having a circular plate shape having an inner zone Z11 (first region) and an outer zone Z12 (second region) divided in the radial direction. The microlens array disk 24a is rotated in a circumferential direction about a shaft core O illustrated in FIG. 1.

A plurality of microlenses ML1 are provided in the inner zone Z11 of the microlens array disk 24a, and a plurality of microlenses ML2 are provided in the outer zone Z12. The microlenses ML1 provided in the inner zone Z11 and the microlenses ML2 provided in the outer zone Z12 differ from each other in kind. For example, the microlenses ML1 and the microlenses ML2 may differ in size, may differ in planar shape, or may differ in optical characteristics. The microlenses ML1 and ML2 illustrated in FIG. 2A as an example have a circular planar shape. The focal distances of the microlenses ML1 provided in the inner zone Z11 are set to twice the focal distances of the microlenses ML2 provided in the outer zone Z12, and this will be described below in detail.

The microlenses ML1 are disposed in the inner zone Z11 in a predetermined pattern (for example, equal-pitch spiral disposition). The microlenses ML2 are disposed in the outer zone Z12 in a predetermined pattern (for example, equal-pitch spiral disposition). It is desirable for the microlenses ML2 to be in equal-pitch spiral disposition, for example, but the microlenses ML1 are not necessarily in equal-pitch spiral disposition.

A first illumination region R11 irradiated with the parallel light L2 (circularly polarized light) output from the ¼ wavelength plate 23 is set in the inner zone Z11 of the microlens array disk 24a. The planar shape of the first illumination region R11 may be an arbitrary shape. However, for example, it is a circular shape. A second illumination region R12 irradiated with the split light L3 (S-polarized light) reflected by the reflection mirror 26 is set in the outer zone Z12 of the microlens array disk 24a. The planar shape of the second illumination region R12 is a circular shape. This is because the planar shapes of the microlenses ML1 formed in the inner zone Z11 of the microlens array disk 24a are circular shapes.

As illustrated in FIG. 2B, the pinhole array disk 24b is a disk having a circular plate shape having an inner zone Z21 (first region) and an outer zone Z22 (second region) divided in the radial direction correspondingly to the microlens array disk 24a. The microlens array disk 24a and the pinhole array disk 24b are individually connected to the rotation shaft 24c and are disposed in a manner of facing each other with a certain gap therebetween. In addition, the pinhole array disk 24b is rotated together with the microlens array disk 24a in the circumferential direction about the shaft core O illustrated in FIG. 1.

A reflection mirror RM is provided in the inner zone Z21 of the pinhole array disk 24b. This reflection mirror RM reflects the split light L3 which has been transmitted through the microlenses ML1 provided in the inner zone Z11 of the microlens array disk 24a toward the microlenses ML1. The reflection mirror RM is realized by forming a dielectric multilayer film on a glass substrate that is the base material of the pinhole array disk 24b, for example. A plurality of pinholes PH corresponding to the microlenses ML2 provided in the outer zone Z12 of the microlens array disk 24a are provided in the outer zone Z22. Similarly to the microlenses ML2, the pinholes PH are disposed in the outer zone Z22 in a predetermined pattern (for example, equal-pitch spiral disposition).

A region R21 within the inner zone Z21 illustrated in FIG. 2B is a region irradiated with the split light L3 which has been transmitted through the microlenses ML1 within the first illumination region R11 set in the inner zone Z11 of the microlens array disk 24a. A region R22 within the outer zone Z22 illustrated in FIG. 2B is a region irradiated with light which has been transmitted through the microlenses ML2 within the second illumination region R12 set in the outer zone Z12 of the microlens array disk 24a.

The microlenses ML1 provided in the inner zone Z11 of the microlens array disk 24a and the reflection mirror RM provided in the inner zone Z21 of the pinhole array disk 24b constitute a part of the homogenizer. The microlenses ML2 provided in the outer zone Z12 of the microlens array disk 24a and the pinholes PH provided in the outer zone Z22 of the pinhole array disk 24b constitute a part of the confocal optical system.

Widths of the inner zone Z11 and the outer zone Z12 of the microlens array disk 24a in the radial direction may be the same or differ from each other. Similarly, widths of the inner zone Z21 and the outer zone Z22 of the pinhole array disk 24b in the radial direction may be the same or differ from each other.

Here, the gap between the microlens array disk 24a and the pinhole array disk 24b is set in accordance with the focal distances of the microlenses ML2 provided in the outer zone Z12 of the microlens array disk 24a. As described above, the focal distances of the microlenses ML1 provided in the inner zone Z11 of the microlens array disk 24a are set to twice the focal distances of the microlenses ML2 provided in the outer zone Z12. For this reason, the gap between the microlens array disk 24a and the pinhole array disk 24b can also be set to ½ the focal distances of the microlenses ML1 provided in the inner zone Z11 of the microlens array disk 24a.

The rotation shaft 24c is a shaft member to which the microlens array disk 24a and the pinhole array disk 24b are individually fixed and connects the microlens array disk 24a and the pinhole array disk 24b. A center portion of the microlens array disk 24a is fixed to a tip portion of the rotation shaft 24c. In addition, the pinhole array disk 24b is fixed to a middle part of the rotation shaft 24c. In addition, the motor 24d is connected to a proximal portion of the rotation shaft 24c.

The motor 24d is connected to the rotation shaft 24c and generates power for rotating the rotation shaft 24c about the shaft core O. The motor 24d rotatively drives the microlens array disk 24a and the pinhole array disk 24b in the circumferential direction about the rotation shaft 24c by rotating the rotation shaft 24c. Namely, when the rotation shaft 24c is rotatively driven by the motor 24d, the microlens array disk 24a and the pinhole array disk 24b can integrally rotate around the rotation shaft 24c.

In the present embodiment, regarding the motor 24d, as illustrated in FIG. 1, the motor 24d is disposed on a side of the pinhole array disk 24b opposite to the microlens array disk 24a. However, the motor 24d may be disposed on a side of the microlens array disk 24a opposite to the pinhole array disk 24b.

The Fourier lens 25 is a lens disposed between the polarization beam splitter 22 and the reflection mirror 26, and the split light L3 (S-polarized light) reflected by the polarization beam splitter 22 is input thereto. Here, the split light L3 is light realized when the parallel light L2 is split into a plurality of luminous fluxes by the microlens array disk 24a. The Fourier lens 25 condenses and spatially superimposes the plurality of luminous fluxes in the second illumination region R12 provided in the outer zone Z12 of the microlens array disk 24a. Namely, the Fourier lens 25 is disposed on an optical path of the split light L3 and forms a Koehler illumination system together with the microlenses ML1 provided in the inner zone Z11 of the microlens array disk 24a.

The reflection mirror 26 is disposed in a manner of facing the polarization beam splitter 22 with the Fourier lens 25 interposed therebetween. When viewed in a direction along the shaft core O, the reflection mirror 26 is disposed at a position with the shaft core O interposed therebetween with respect to the polarization beam splitter 22. This reflection mirror 26 reflects the split light L3 (S-polarized light) reflected by the polarization beam splitter 22 toward the second illumination region R12 set in the outer zone Z12 of the microlens array disk 24a.

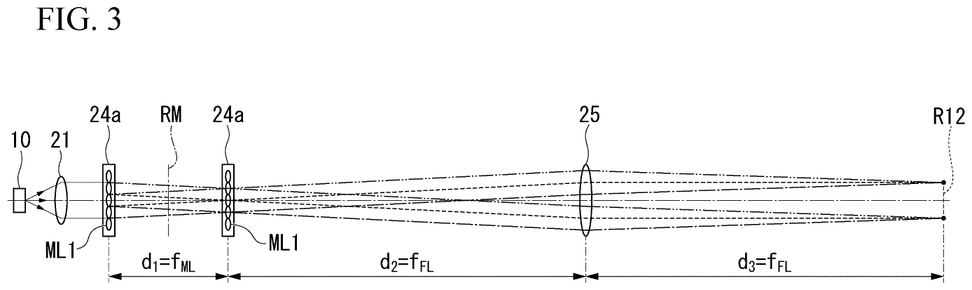

FIG. 3 is a development view linearly illustrating in the embodiment of the present invention, an optical path from a light source to a second irradiation surface. In FIG. 3, illustration of the polarization beam splitter 22, the ¼ wavelength plate 23, and the reflection mirror 26 is omitted. In addition, regarding the pinhole array disk 24b, only the reflection mirror RM is omitted.

As described above, the Fourier lens 25 forms the Koehler illumination system together with the microlenses ML1 provided in the inner zone Z11 of the microlens array disk 24a. Specifically, the Fourier lens 25 is disposed such that a front-side focal plane thereof coincides with a rear-side focal plane of the microlenses ML1. As illustrated in FIG. 3, the rear-side focal plane of the microlenses ML1 is set to coincide with main surfaces of the microlenses ML1 by the reflection mirror RM. For this reason, the Fourier lens 25 can also be disposed such that the front-side focal plane thereof coincides with the main surfaces of the microlenses ML1.

For example, when a distance (focal distance) fML from main points of the microlenses ML1 to the rear focal plane is a distance d1 and a distance (focal distance) fFL from a main point of the Fourier lens 25 to the front focal plane is a distance d2, the distance from the main points of the microlenses ML1 to the main point of the Fourier lens 25 becomes d1+d2. In addition, when the distance (focal distance) fFL from the main point of the Fourier lens 25 to the rear focal plane is a distance d3, the distance from the main points of the microlenses ML1 to the second illumination region R12 becomes d1+d2+d3. Namely, in the confocal scanner 20 of the present embodiment, the optical path length of the split light L3 from the main points of the microlenses ML1, in which the split light L3 is emitted, to the second illumination region R12 becomes d1+d2+d3.

In such a Koehler illumination system formed by the microlenses ML1 and the Fourier lens 25, the parallel light L2 is converted into the split light L3 by being split into a plurality of luminous fluxes by the microlenses ML1. The luminous fluxes of the split light L3 converge at a focal point of each of the microlenses ML1, then diverge again, are reflected by the reflection mirror RM, are directed toward the Fourier lens 25. Each of the luminous fluxes which has passed through the Fourier lens 25 becomes a parallel beam again, is reflected by the reflection mirror 26, and is used for irradiating a focal plane (that is, the second illumination region R12) of the Fourier lens 25 in a superimposed manner.

Returning to FIG. 1, the dichroic mirror 27 is disposed between the microlens array disk 24a and the pinhole array disk 24b. The dichroic mirror 27 allows the plurality of luminous fluxes which have split and converged by the microlenses ML2 within the second illumination region R12 to be transmitted therethrough. Luminous fluxes which have been transmitted through the dichroic mirror 27 are condensed in the pinholes PH provided in the pinhole array disk 24b, pass through the pinholes PH, and are emitted to the outside of the disk unit 24. At this time, since light used for irradiating the second illumination region R12 is parallel light with a uniform intensity distribution, the illumination light LA which passes through the pinholes PH and is emitted to the outside of the disk unit 24 also has a uniform intensity distribution.

In addition, the dichroic mirror 27 reflects the return light L5, of the return light L5 obtained by irradiating the sample SP with the illumination light LA, which has been transmitted through the pinholes PH provided in the pinhole array disk 24b toward the optical filter 28 disposed on the outward side in the radial direction about the shaft core O.

The optical filter 28 filters the return light L5 reflected by the dichroic mirror 27. A polarizing filter, an absorption filter (emission filter), a dichroic mirror, or the like can be used as this optical filter 28. The relay lens 29 disposed between the optical filter 28 and the camera 40 and induces the return light L5 emitted through the optical filter 28 to the camera 40.

The microscope 30 irradiates the sample SP with illumination light generated by the disk unit 24 and induces the return light L5 obtained by irradiating the sample SP with the illumination light LA to the disk unit 24. The microscope 30 is an infinity correction optical system including an objective lens 31, for example. In FIG. 1, for the sake of convenience, the sample SP inside the microscope 30 is illustrated, but it should be noted that the sample SP does not constitute the microscope 30 and that the sample SP is replaceable.

The camera 40 captures a confocal image of the sample SP irradiated with the illumination light LA. This camera 40 is a camera including a solid-state image capturing element such as a charge coupled device (CCD) or a complementary metal oxide semiconductor (CMOS), for example, and capable of capturing two-dimensional still images or video images. For example, a display device (not illustrated) may display a confocal image of the sample SP obtained by the camera 40.

### Operation of Confocal Microscope

When operation of the confocal microscope 1 starts, light (P-polarized light) is output from the light source unit 10, and rotation of the disk unit 24 (rotation around the rotation shaft 24c) starts. The light L1 output from the light source unit 10 is input to the confocal scanner 20. It is assumed that light output from the light source unit 10 is light having an intensity distribution (for example, light having a Gaussian distribution).

The light L1 input to the confocal scanner 20 is incident on the collimating lens 21 first and is converted into the parallel light L2 (P-polarized light) by the collimating lens 21. The parallel light L2 which has been converted into P-polarized light is transmitted through the polarization beam splitter 22 and is then converted into circularly polarized light by the ¼ wavelength plate 23. The parallel light L2 which has been converted into circularly polarized light is used for irradiating the first illumination region R11 set in the inner zone Z11 of the microlens array disk 24a and is converted into the split light L3 by the microlenses ML1 within the first illumination region R11.

The converted split light L3 travels toward the inner zone Z21 of the pinhole array disk 24b and is reflected by the reflection mirror RM provided in the inner zone Z21. The split light L3 reflected by the reflection mirror RM is transmitted again through the microlenses ML1 within the first illumination region R11 set in the inner zone Z11 of the microlens array disk 24a. The split light L3 which has been transmitted through the microlenses ML1 is incident on the ¼ wavelength plate 23 and is converted into S-polarized light. The split light L3 which has been converted into S-polarized light is reflected by the polarization beam splitter 22 and is used for irradiating the second illumination region R12 set in the outer zone Z12 of the microlens array disk 24a through the Fourier lens 25 and the reflection mirror 26.

Here, the microlenses ML1 provided in the inner zone Z11 of the microlens array disk 24a and the Fourier lens 25 form the Koehler illumination system as described above. For this reason, the luminous fluxes of the split light L3 converge at the focal point of each of the microlenses ML1, then diverge again, become a parallel beam again by the Fourier lens 25, and are used for irradiating the second illumination region R12 in a superimposed manner. Accordingly, the second illumination region R12 is irradiated with parallel light having a uniform intensity distribution.

Light used for irradiating the second illumination region R12 is split into a plurality of luminous fluxes by the plurality of microlenses ML2. Each of the luminous fluxes converges by the microlenses ML2 and passes through the pinholes PH provided in the outer zone Z22 of the pinhole array disk 24b. At this time, the illumination light L4 emitted from the microlenses ML1 is transmitted through the dichroic mirror 27 and is incident on the pinhole array disk 24b. The illumination light LA emitted through the pinholes PH is emitted to the outside of the disk unit 24.

The illumination light LA emitted to the outside of the disk unit 24 is used for irradiating the sample SP through the objective lens 31 provided in the microscope 30. Here, the illumination light LA emitted to the outside of the disk unit 24 is obtained by splitting light having a uniform intensity distribution. For this reason, the sample SP is irradiated with illumination light having a uniform intensity distribution.

The return light L5 from the sample SP (return light obtained by irradiating the sample SP with illumination light) is incident on the pinhole array disk 24b of the disk unit 24 through the objective lens 31 provided in the microscope 30. Further, the light goes through the pinholes PH provided in the outer zone Z22 of the pinhole array disk 24b and is then reflected by the dichroic mirror 27 toward the optical filter 28.

The return light L5 reflected by the dichroic mirror 27 is incident on the camera 40 through the optical filter 28 and the relay lens 29 in this order and forms an image. Here, since the disk unit 24 rotates around the rotation shaft 24c, the illumination light LA used for irradiating the sample SP is used for scanning in response to rotation of the disk unit 24. Accordingly, the return light L5 is sequentially input to the camera 40 in accordance with the scanning position of the illumination light LA. In this manner, a confocal image of the sample SP is obtained by the camera 40.

As above, the confocal microscope 1 of the present embodiment includes the disk unit 24 having the microlens array disk 24a and the pinhole array disk 24b. The microlens array disk 24a has the inner zone Z11 and the outer zone Z12 divided in the radial direction. The pinhole array disk 24b has the inner zone Z21 and the outer zone Z22 divided in the radial direction correspondingly to the microlens array disk 24a and rotates together with the microlens array disk 24a.

The plurality of microlenses ML1 are provided in the inner zone Z11 of the microlens array disk 24a, and the plurality of microlenses ML2 are provided in the outer zone Z12. The reflection mirror RM reflecting light which has been transmitted through the microlenses ML1 provided in the inner zone Z11 of the microlens array disk 24a toward the microlenses ML1 is provided in the inner zone Z21 of the pinhole array disk 24b. The plurality of pinholes PH corresponding to the microlenses ML2 provided in the outer zone Z12 of the microlens array disk 24a are provided in the outer zone Z22 of the pinhole array disk 24b.

Light which has been transmitted through the microlenses ML1 provided in the inner zone Z11 of the microlens array disk 24a is reflected by the reflection mirror RM provided in the inner zone Z21 of the pinhole array disk 24b. Light reflected by the reflection mirror RM is transmitted through the microlenses ML1 provided in the inner zone Z11 of the microlens array disk 24a again. Accordingly, a part of the homogenizer is constituted. In this manner, in the present embodiment, since the reflection mirror RM is provided in the inner zone Z21 of the pinhole array disk 24b and the reflection mirror which has been required in the related art is no longer required, a constitution having fewer components than in the related art can be realized.

In addition, in the present embodiment, a plurality of microlenses ML2 are provided in the outer zone Z12 of the microlens array disk 24a. A plurality of pinholes PH corresponding to the microlenses ML2 provided in the outer zone Z12 of the microlens array disk 24a are provided in the outer zone Z22 of the pinhole array disk 24b. Accordingly, a part of the confocal optical system is constituted.

Here, the microlenses ML1 provided in the inner zone Z11 of the microlens array disk 24a and the microlenses ML2 provided in the outer zone Z12 can be individually designed. For this reason, a microlens array disk optimal for a homogenizer and a microlens array disk optimal for a confocal optical system can be individually designed. Accordingly, a high-definition confocal image having a further improved uniform brightness can be obtained.

### MODIFICATION EXAMPLES

### First Modification Example

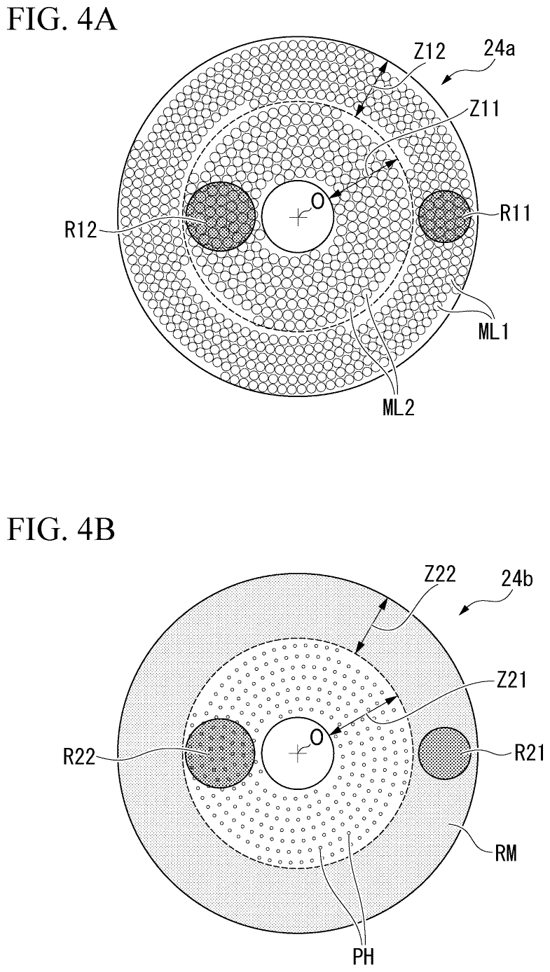

FIG. 4 is a plan view illustrating a first modification example of the microlens array disk and the pinhole array disk provided in the disk unit. FIG. 4A is a plan view illustrating the first modification example of the microlens array disk 24a, and FIG. 4B is a plan view illustrating the first modification example of the pinhole array disk 24b.

In the microlens array disk 24a illustrated in FIG. 4A, the function of the inner zone Z11 and the function of the outer zone Z12 of the microlens array disk 24a illustrated in FIG. 2A are reversed. Namely, in the microlens array disk 24a illustrated in FIG. 4A, the microlenses ML1 are provided in the outer zone Z12, and the microlenses ML2 are provided in the inner zone Z11. Further, the first illumination region R11 is set in the outer zone Z12, and the second illumination region R12 is set in the inner zone Z11.

In the pinhole array disk 24b illustrated in FIG. 4B, the function of the inner zone Z21 and the function of the outer zone Z22 of the pinhole array disk 24b illustrated in FIG. 2B are reversed. Namely, in the pinhole array disk 24b illustrated in FIG. 4B, the reflection mirror RM is provided in the outer zone Z22, and the pinholes PH are provided in the inner zone Z21.

As illustrated in FIG. 4A, in the microlens array disk 24a, the first illumination region R11 is set in the outer zone Z12, and the second illumination region R12 is set in the inner zone Z11. For this reason, as illustrated in FIG. 4B, the region R21 (a region irradiated with the split light L3 which has been transmitted through the microlenses ML1 within the first illumination region R11) is disposed in the outer zone Z22, and the region R22 (a region irradiated with light which has been transmitted through the microlenses ML2 within the second illumination region R12) is disposed in the inner zone Z21.

In the present modification example, a part of the homogenizer is constituted of the microlenses ML1 provided in the outer zone Z12 of the microlens array disk 24a and the reflection mirror RM provided in the outer zone Z22 of the pinhole array disk 24b.

In addition, a part of the confocal optical system is constituted of the microlenses ML2 provided in the inner zone Z11 of the microlens array disk 24a and the pinholes PH provided in the inner zone Z21 of the pinhole array disk 24b.

### Second Modification Example

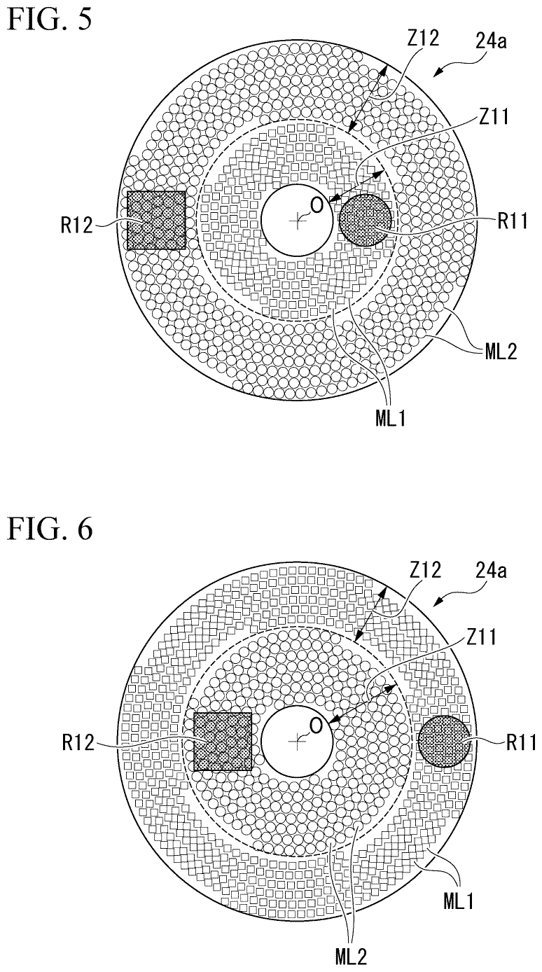

FIG. 5 is a plan view illustrating a second modification example of the microlens array disk provided in the disk unit. In the present modification example, regarding the pinhole array disk 24b provided in the disk unit, the one illustrated in FIG. 2B (the one in which the reflection mirror RM is provided in the inner zone Z21 and the pinholes PH are provided in the outer zone Z22) is used.

The microlens array disk 24a illustrated in FIG. 5 is obtained by changing the shape of the microlenses ML1 provided in the inner zone Z11 of the microlens array disk 24a illustrated in FIG. 2A. Specifically, the planar shapes of the microlenses ML1 are changed from circular shapes to rectangular shapes. In this manner, the reason why the microlenses ML1 having rectangular planar shapes are used is to improve the utilization efficiency of illumination light.

The planar shape of the second illumination region R12 set in the outer zone Z12 of the microlens array disk 24a is similar to the planar shapes of the microlenses ML1. For this reason, if the planar shapes of the microlenses ML1 are rectangular shapes, as illustrated in FIG. 5, the planar shape of the second illumination region R12 can be a rectangular shape. In addition, light used for irradiating the second illumination region R12 is incident on the solid-state image capturing element of the camera 40. Since the solid-state image capturing element of the camera 40 has a rectangular image capturing surface, if the planar shape of the second illumination region R12 is a rectangular shape, light used for irradiating the second illumination region R12 can be thoroughly incident on the solid-state image capturing element of the camera 40. Accordingly, the utilization efficiency of illumination light can be improved. It is desirable that the planar shapes of the microlenses ML1 be similar to the shape of the image capturing surface of the solid-state image capturing element of the camera 40 (the same aspect ratio).

### Third Modification Example

FIG. 6 is a plan view illustrating a third modification example of the microlens array disk provided in the disk unit. In the present modification example, regarding the pinhole array disk 24b provided in the disk unit, the one illustrated in FIG. 4B (the one in which the reflection mirror RM is provided in the outer zone Z22 and the pinholes PH are provided in the inner zone Z21) is used.

In the microlens array disk 24a illustrated in FIG. 6, the function of the inner zone Z11 and the function of the outer zone Z12 of the microlens array disk 24a illustrated in FIG. 5 are reversed. Namely, in the microlens array disk 24a illustrated in FIG. 6, the microlenses ML1 having rectangular planar shapes are provided in the outer zone Z12, and the microlenses ML2 are provided in the inner zone Z11. Further, the first illumination region R11 is set in the outer zone Z12, and the second illumination region R12 is set in the inner zone Z11. In the present modification example as well, similar to the second modification example, the utilization efficiency of illumination light can be improved.

### Fourth Modification Example

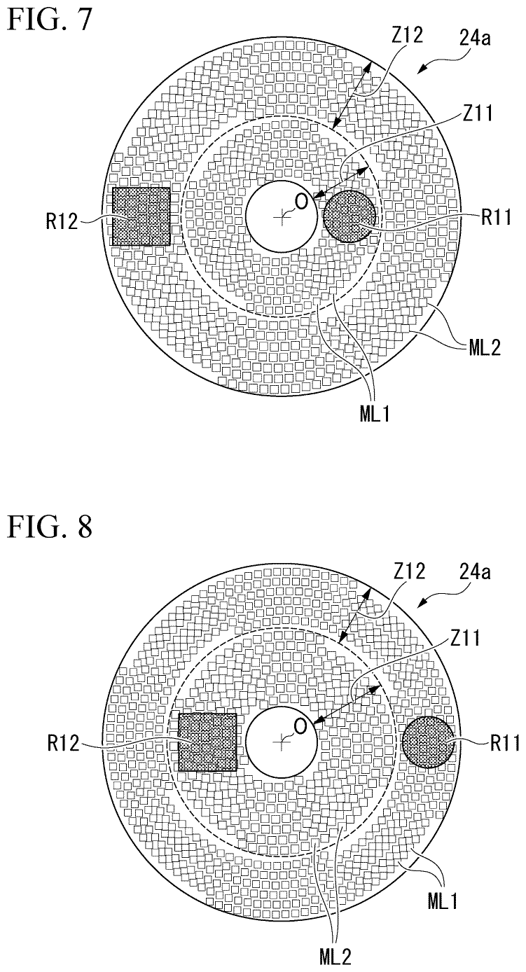

FIG. 7 is a plan view illustrating a fourth modification example of the microlens array disk provided in the disk unit. In the present modification example, regarding the pinhole array disk 24b provided in the disk unit, the one illustrated in FIG. 2B (the one in which the reflection mirror RM is provided in the inner zone Z21 and the pinholes PH are provided in the outer zone Z22) is used.

The microlens array disk 24a illustrated in FIG. 7 is obtained by changing the shape of the microlenses ML2 provided in the outer zone Z12 of the microlens array disk 24a illustrated in FIG. 5. Specifically, the planar shapes of the microlenses ML2 are changed from circular shapes to rectangular shapes. Namely, in the microlens array disk 24a illustrated in FIG. 7, the planar shapes of the microlenses ML1 provided in the inner zone Z11 and the microlenses ML2 provided in the outer zone Z12 are rectangular shapes.

In this manner, the reason why the microlenses ML1 and ML2 having rectangular planar shapes are used is to further improve the utilization efficiency of illumination light. Namely, when the planar shapes of the microlenses ML2 are rectangular shapes, the opening ratio can be increased compared to when the planar shapes are circular shapes. Therefore, the utilization efficiency of illumination light can be improved. Since the utilization efficiency of illumination light can be improved in both the homogenizer and the confocal optical system by causing the planar shapes of both the microlenses ML1 and ML2 to be rectangular shapes, a brighter confocal image of the sample SP can be captured.

### Fifth Modification Example

FIG. 8 is a plan view illustrating a fifth modification example of the microlens array disk provided in the disk unit. In the present modification example, regarding the pinhole array disk 24b provided in the disk unit, the one illustrated in FIG. 4B (the one in which the reflection mirror RM is provided in the outer zone Z22 and the pinholes PH are provided in the inner zone Z21) is used.

The microlens array disk 24a illustrated in FIG. 8 is obtained by changing the shape of the microlenses ML2 provided in the inner zone Z11 of the microlens array disk 24a illustrated in FIG. 6. Specifically, the planar shapes of the microlenses ML2 are changed from circular shapes to rectangular shapes. Namely, in the microlens array disk 24a illustrated in FIG. 8, the planar shapes of the microlenses ML1 provided in the outer zone Z12 and the microlenses ML2 provided in the inner zone Z11 are rectangular shapes.

In the microlens array disk 24a illustrated in FIG. 8, the function of the inner zone Z11 and the function of the outer zone Z12 of the microlens array disk 24a illustrated in FIG. 7 are reversed. Namely, in the microlens array disk 24a illustrated in FIG. 8, the microlenses ML1 having rectangular planar shapes are provided in the outer zone Z12, and the microlenses ML2 having rectangular planar shapes are provided in the inner zone Z11. Further, the first illumination region R11 is set in the outer zone Z12, and the second illumination region R12 is set in the inner zone Z11. In the present modification example as well, similar to the fourth modification example, since the utilization efficiency of illumination light can be improved in both the homogenizer and the confocal optical system, a brighter confocal image of the sample SP can be captured.

Hereinabove, the disk unit, the confocal scanner, and the confocal microscope according to the embodiment of the present invention have been described, but the present invention is not limited to the foregoing embodiment and can be freely changed within the scope of the present invention. For example, in the embodiment described above, an example in which the light L1 emitted from the light source unit 10 is P-polarized light has been described. However, the light L1 output from the light source unit 10 may be S-polarized light. In such a case, a polarization beam splitter which allows S-polarized light to be transmitted therethrough and reflects P-polarized light may be used as the polarization beam splitter 22.

### REFERENCE SIGNS LIST

1 Confocal microscope
10 Light source unit
22 Polarization beam splitter
23 ¼ wavelength plate
24 Disk unit
24a Microlens array disk
24b Pinhole array disk
24c Rotation shaft
24d Motor
25 Fourier lens
26 Reflection mirror
27 Dichroic mirror
40 Camera
L1 Light
L3 Split light
L4 Illumination light
ML1, ML2 Microlens
PH Pinhole
R11 First illumination region
R12 Second illumination region
RM Reflection mirror
SP Sample
Z11, Z21 Inner zone
Z12, Z22 Outer zone

1: A disk unit comprising:
a first disk that has a first region and a second region divided in a radial direction; and
a second disk that has a first region and a second region divided in the radial direction correspondingly to the first disk and rotates together with the first disk while having the other surface disposed in a manner of facing one surface of the first disk,
wherein a plurality of microlenses are provided in the first region and the second region of the first disk,
wherein a reflection mirror reflecting light which has been transmitted through the microlenses provided in either one of the first region or the second region of the first disk toward the microlenses is provided in either one of the first region or the second region of the second disk, and
wherein a plurality of pinholes corresponding to the microlenses provided in the other of the first region and the second region of the first disk are provided in the other of the first region and the second region of the second disk.

2: The disk unit according to claim 1,
wherein the microlenses provided in the first region of the first disk and the microlenses provided in the second region of the first disk differ from each other in kind.

3: The disk unit according to claim 1,
wherein the microlenses provided in the second region of the first disk are disposed in a spiral shape.

4: The disk unit according to claim 1,
wherein focal distances of the microlenses provided in either one of the first region or the second region of the first disk are twice focal distances of the microlenses provided in the other of the first region and the second region of the first disk.

5: The disk unit according to claim 1,
wherein planar shapes of the microlenses provided in at least one of the first region and the second region of the first disk are circular shapes or rectangular shapes.

6: The disk unit according to claim 1 further comprising:
a coupling shaft that connects the first disk and the second disk; and
a drive unit that rotatively drives the coupling shaft.

7: A confocal scanner comprising:
the disk unit according to claim 1;
light induction units that form a Koehler illumination system together with the microlenses within a first illumination region set in either one of the first region or the second region of the first disk and induce a plurality of rays of split light split by the microlenses within the first illumination region into a second illumination region set in the other of the first region and the second region of the first disk; and
a beam splitter that is disposed between one surface of the first disk and the other surface of the second disk, allows light through the microlenses within the second illumination region to be transmitted therethrough, and reflects light incident from the second disk side toward an outward side of the first disk and the second disk in the radial direction.

8: The confocal scanner according to claim 7,
wherein the light induction units include:
a polarization beam splitter which allows light in a first polarization state to be transmitted therethrough and reflects light in a second polarization state;
a ¼ wavelength plate which is disposed between the polarization beam splitter and the first disk, converts light in the first polarization state which has been transmitted through the beam splitter into light in a third polarization state, and converts the split light in the third polarization state into light in the second polarization state;
a split light guide unit which guides the split light reflected by the polarization beam splitter to the second illumination region; and
a Fourier lens which is disposed in an optical path of the split light and forms a part of the Koehler illumination system.

9: A confocal microscope comprising:
the confocal scanner according to claim 7 emitting illumination light for scanning a sample;
a light source unit that outputs light for generating the illumination light; and
an image capturing device that captures an image of a confocal image of the sample.
